(19) United States
(12) Patent Application Publication
(10) Pub. No.: US 2023/0151197 A1
(43) Pub. Date: May 18, 2023

(54) RESIN COMPOSITION AND PRODUCTION METHOD THEREOF

(71) Applicant: KONICA MINOLTA, INC., Tokyo (JP)

(72) Inventors: Yo NAKAJIMA, Okaya-shi (JP); Masashi MAMINO, Tokyo (JP); Takeshi KOJIMA, Tokyo (JP); Yuuki NAGAI, Tokyo (JP)

(73) Assignee: KONICA MINOLTA, INC., Tokyo (JP)

(21) Appl. No.: 18/052,721

(22) Filed: Nov. 4, 2022

(30) Foreign Application Priority Data
Nov. 12, 2021 (JP) 2021-184526

(51) Int. Cl. C08L 23/12; C08L 79/02

(52) U.S. Cl. CPC C08L 23/12; C08L 79/02; C08L 2201/22; C08L 2666/72; C08K 2003/026

(57) ABSTRACT

Provided is a halogen-free resin composition including a polyolefin resin, containing a phosphorus compound in an amount of 0.05 to 2.5 mass % as a phosphorus content; a NOR-type hindered amine in an amount of 0.05 to 5 mass %; and an inorganic filler in an amount of 3 to 50 mass %, respectively, with respect to the total amount of the resin composition, wherein a DTA (Differential Thermal Analysis) curve obtained by differential thermal analysis of the inorganic filler has an endothermic portion in a temperature range of 180 to 500° C.; and in the inorganic filler, a ratio value of a number of particles having a maximum diameter of 300 μm or more to a number of particles having a maximum diameter of 100 μm or more is ⅕ or less, or there are no particles having a maximum diameter of 100 μm or more.

### CROSS-REFERENCE TO RELATED APPLICATIONS

The entire disclosure of Japanese Patent Application No. 2021-184526 filed on Nov. 12, 2021 is incorporated herein by reference in its entirety.

### BACKGROUND

### Technological Field

The present invention relates to a resin composition and a method for producing the same. More particularly, the present invention relates to a resin composition of a polyolefin resin that is halogen-free and excellent in flame retardancy, wherein the resulting molded product has excellent mechanical properties of toughness and rigidity, and the present invention relates to a method for producing the same.

### Description of the Related Art

Polyolefin resins represented by polypropylene are used in various applications because of their low carbon dioxide emissions during manufacture, light weight, excellent chemical resistance, high elongation and low cost.

On the other hand, polyolefin resins are flammable, and when flame retardancy is required for molded products, the resin compositions for molding are used in which large amounts of flame retardants are added to the resin. However, the addition of flame retardants may impair the above characteristics of polyolefin resins. As flame retardants, various flame retardants such as halogen compounds, phosphorus compounds, and metal hydrates are conventionally known.

However, since halogen-based compounds are harmful, there is a demand for halogen-free flame retardant technology. For example, it is known that metal hydroxide is used as a flame retardant to achieve halogen-free flame retardancy. However, in this case, in order to obtain sufficient flame retardancy, a large amount of metal hydroxide must be added, and there is a problem that the mechanical strength of the resulting molded product is reduced.

Among the hindered amine light stabilizers known as light stabilizers, NOR-type hindered amine compounds (hereinafter referred to as “NOR-type HALS”) are used as flame retardants. For example, Patent Document 1 (JP-A 2015-189785) describes a technology in which a reduction in toughness of a molded product obtained by compounding an elastomer is suppressed while achieving flame retardancy by using a combination of a phosphorus compound and a NOR-type HALS. However, the technology described in Patent Document 1 has a problem in that sufficient rigidity is not given to the molded product.

### SUMMARY

The present invention was made in view of the above problems and circumstances, and an object of the present invention is to provide a polyolefin resin composition having excellent flame retardancy while being halogen-free, and the resulting molded product having excellent mechanical properties of toughness and rigidity, and a production method thereof.

In the process of studying the cause of the above problem, the present inventor found the following. By including a phosphorus compound, a NOR-type hindered amine, and an inorganic filler having a specified heat absorption property and a specified particle size property with specific proportions in a halogen-free resin composition including a polyolefin resin, a molded product having excellent mechanical properties of toughness and rigidity and flame resistance is produced. In other words, the above-mentioned problems pertaining to the present invention are solved by the following means.

To achieve at least one of the above-mentioned objects of the present invention, a halogen-free resin composition including a polyolefin resin that reflects an aspect of the present invention is as follows.

A halogen-free resin composition including a polyolefin resin, containing

a phosphorus compound in an amount of 0.05 to 2.5 mass % as a phosphorus content;

a NOR-type hindered amine in an amount of 0.05 to 5 mass %; and

an inorganic filler in an amount of 3 to 50 mass %, respectively, with respective to the total amount of the resin composition,

wherein a DTA (Differential Thermal Analysis) curve obtained by differential thermal analysis of the inorganic filler has an endothermic portion in a temperature range of 180 to 500° C.; and

in the inorganic filler, a ratio value of a number of particles having a maximum diameter of 300 μm or more to a number of particles having a maximum diameter of 100 μm or more is ⅕ or less, or there are no particles having a maximum diameter of 100 μm or more.

By the above means of the present invention, it is possible to provide a resin composition of a polyolefin resin that is halogen-free and has excellent flame retardancy and the resulting molded product has excellent mechanical properties of toughness and rigidity, and a manufacturing method thereof.

The expression mechanism or action mechanism of the effect of the present invention is inferred as follows.

Combustion of plastics is composed of multiple processes, and it is difficult to obtain high flame retardancy by completely blocking any one process while maintaining mechanical strength such as toughness and rigidity. The present inventor has found that by suppressing multiple processes through multiple flame retardant mechanisms, it is possible to impart high flame retardancy to a molded product of a halogen-free polyolefin resin composition, and that in this method, the mechanical strength such as toughness and rigidity of the molded product may also be improved.

Specifically, a phosphorus compound has flame retardant effects such as radical trapping and plasticization, while a NOR-type HALS has flame retardant effects such as radical trapping and reduction in molecular weight during combustion. On the other hand, increasing the content of these in polyolefin resin compositions in order to obtain sufficient flame retardant effects leads to a decrease in the mechanical properties of the molded products and an increase in cost.

The inclusion of an endothermic inorganic filler in a polyolefin resin composition will provide the flame retardant effect due to heat absorption that is not possessed by phosphorus compounds and NOR-type HALS. Furthermore, as explained below, by adjusting the particle size distribution of the inorganic filler, the drip characteristics during combustion of the molded product may be adjusted to further improve the flame retardant properties.

The inorganic filler is heavier than the polyolefin resin, and has an effect of increasing the melt tension and acting as a crack source for breakage to promote dripping. It also has an effect of increasing the melt viscosity and suppressing the drip so as to compete with each other. By adjusting the particle size of the inorganic filler to a predetermined range, the number of crack sources and melt viscosity may be adjusted in a balanced manner and the drip-promoting effect may be given to the molded product. Specifically, the effect of facilitating dripping makes it easier to drop sparks and helps extinguish fires. Furthermore, mechanical strength may also be imparted if it is within the above range.

In the present invention, the phosphorus compound, the NOR-type HALS, and the inorganic filler having the specified endothermic property and the particle size property are contained in a specific amount respectively. Thereby it is possible to provide a resin composition of a polyolefin resin which is halogen-free and has excellent flame retardancy and the resulting molded product has excellent mechanical properties of toughness and rigidity.

### BRIEF DESCRIPTION OF THE DRAWINGS

The advantages and features provided by one or more embodiments of the invention will become more fully understood from the detailed description given hereinbelow and the appended drawing which are given by way of illustration only, and thus are not intended as a definition of the limits of the present invention.

FIG. 1 is a cross-sectional image of a resin composition obtained in Example 1 taken with an electron microscope (300 times).

FIG. 2 is a cross-sectional image of a resin composition obtained in Example 1 taken with an electron microscope (5000 times).

FIG. 3 is a DTA curve obtained by differential thermal analysis of aluminum hydroxide particles (KH-101).

FIG. 4 is a DTA curve obtained by differential thermal analysis of calcium carbonate particles (CALCEEDS P).

FIG. 5 is a DTA curve obtained by differential thermal analysis of a resin composition obtained in Example 1.

### DETAILED DESCRIPTION OF THE EMBODIMENTS

Hereinafter, one or more embodiments of the present invention will be described. However, the scope of the present invention is not limited to the disclosed embodiments.

The resin composition of the present invention is a halogen-free resin composition including a polyolefin resin, wherein the resin composition contains a phosphorus compound in an amount of 0.05 to 2.5 mass % as a phosphorous content, a NOR-type hindered amine in an amount of 0.05 to 3 mass %, and an inorganic filler in an amount of 3 to 50 mass %, respectively, with respect to the total amount of the resin composition; and a DTA curve obtained by differential thermal analysis of the inorganic filler has an endothermic portion in a temperature range of 180 to 500° C., and a ratio value of a number of particles having a maximum diameter of 300 μm or more to a number of particles having a maximum diameter of 100 μm or more is ⅕ or less, or there are no particles having a maximum diameter of 100 μm or more. This feature is a technical feature common to each of the following embodiments.

As an embodiment of the resin composition of the present invention, form the viewpoint of exhibiting the effect of the present invention, it is preferable that the resin composition contains the inorganic filler composed of at least one selected from the group of aluminum hydroxide particles, boehmite particles, magnesium hydroxide particles, and hydromagnesite particles, and at least one selected from the group of wollastonite particles, talc particles, mica particles, glass particles, kaolin particles, magnesium sulfate particles, calcium carbonate particles, and silica particles.

As an embodiment of the resin composition of the present invention, it is preferred that the polyolefin resin is a polypropylene-based resin in the point that the effect of the present invention is more pronounced.

As an embodiment of the resin composition of the present invention, it is preferred that the phosphorus compound includes a phosphate ester compound from the viewpoint of more remarkably exhibiting the effect of the present invention.

As an embodiment of the resin composition of the present invention, from the viewpoint of exhibiting the effect of the present invention, it is preferable that the resin composition has an endothermic portion in a temperature range of 180 to 350° C. in a DTA curve obtained by differential thermal analysis of the resin composition under a temperature increase condition of 10° C./minute.

As an embodiment of the resin composition of the present invention, from the viewpoint of exhibiting the effect of the present invention, the phosphorus compound is contained in an amount of 0.1 to 1.5 mass % as a phosphorus content, the NOR-type hindered amine is contained in an amount of 0.1 to 2 mass %, and the inorganic filler is contained in an amount of 10 to 30 mas %, respectively, and the inorganic filler contains an endothermic inorganic filler whose DTA curve obtained by differential thermal analysis exhibits an endothermic portion in a temperature range of 180 to 500° C. in an amount of 5 mass % or more with respect to the total amount of the resin composition, moreover, the inorganic filler preferably satisfies the following (a) or (b).

(a) A ratio value of a number of particles having a maximum diameter of 200 μm or more to a number of particles having a maximum diameter of 100 μm or more is 1/10 or less, or there are no particles having a maximum diameter of 100 μm or more, and a ratio value of a number of particles having a maximum diameter of less than 5 μm to a number of particles having a maximum diameter of 5 μm or more is 10 or more.

(b) There are no particles having a maximum diameter of 5 μm or more.

The inorganic filler contained in the resin composition of the present invention contains at least the above-mentioned endothermic inorganic filler. Since the inorganic filler contained in the resin composition of the present invention contains the endothermic inorganic filler, the DTA curve obtained by differential thermal analysis has an endothermic portion in the temperature range of 180 to 500° C. Further, in order to keep the particle size of the inorganic filler within a predetermined range, the inorganic filler may contain a non-endothermic inorganic filler that does not show an endothermic portion in the temperature range of 180 to 500° C. in the DTA curve obtained by differential thermal analysis.

As an embodiment of the resin composition of the present invention, from the viewpoint of exhibiting the effect of the present invention, it is further preferred to contain a fatty acid or a salt thereof.

The method for producing a resin composition of the present invention is a method including a step of kneading raw material components containing the polyolefin resin, the phosphorus compound, the NOR-type hindered amine, and the inorganic filler with a twin-screw extruder.

Hereinafter, the present invention, its constituent elements, and modes and embodiments for carrying out the present invention will be described in detail. In this application, “to” is used in the sense of including the numerical values described before and after “to” as a lower and an upper limit, respectively.

### [Resin Composition]

The resin composition of the present invention is a halogen-free resin composition including a polyolefin resin, wherein the resin composition contains a phosphorus compound in an amount of 0.05 to 2.5 mass % as a phosphorous content, a NOR-type hindered amine in an amount of 0.05 to 5 mass %, and an inorganic filler in an amount of 5 to 50 mass %, respectively, with respect to the total amount of the resin composition; and a DTA curve obtained by differential thermal analysis of the inorganic filler has an endothermic portion in a temperature range of 180 to 500° C., and a ratio value of a number of particles having a maximum diameter of 300 μm or more to a number of particles having a maximum diameter of 100 μm or more is ⅕ or less, or there are no particles having a maximum diameter of 100 μm or more.

In the following description, a phosphorus compound may be referred to as component (A), a NOR-type hindered amine as component (B), and an inorganic filler satisfying the requirements of (1) and (2) below as component (C).
(1) The DTA curve obtained by differential thermal analysis has an endothermic portion in the temperature range of 180 to 500° C.
(2) The ratio value of the number of particles having a maximum diameter of 300 μm or more to the number of particles having a maximum diameter of 100 μm or more is ⅕ or less, or there are no particles having a maximum diameter of 100 μm or more.

The resin composition of the present invention is a halogen-free resin composition. In the present invention, the resin composition is “halogen-free” means that, for example, the content of chlorine is 900 mass ppm or less, the content of bromine is 900 mass ppm or less, and the total content of chlorine and bromine is 1500 mass ppm or less.

The content of halogen elements in the resin composition may be determined, for example, by flask combustion treatment ion chromatography, wavelength dispersive X-ray analysis, or inductively coupled plasma emission spectrometry.

The resin composition of the present invention may optionally contain a fatty acid or a salt thereof in addition to the above components to the extent that the effect of the present invention is not impaired. Further, the resin composition of the present invention may optionally contain, in addition to the above components, other resins other than polyolefin resins and various additives generally contained in resin compositions, to the extent that the effect of the present invention is not impaired. Each component in the resin composition of the present invention will be described below.

### (Polyolefin Resin)

A polyolefin resin is a homopolymer or copolymer polymerized with an olefin as a main monomer component. In this specification, an “olefin” refers to an aliphatic chain unsaturated hydrocarbon having one double bond.

Here, the main component constituting the resin (polymer) means a component having an amount of 50 mass % or more in all the monomer components constituting the polymer. The polyolefin resin is a homopolymer or a copolymer containing an olefin in all monomer components, preferably in an amount of 60 to 100 mass %, more preferably 70 to 100 mass %, still more preferably 80 to 100 mass %.

The olefin copolymer includes a copolymer of an olefin with other olefin, or a copolymer of an olefin with other monomer copolymerizable to the olefin. The content of the above other monomer in the polyolefin resin is preferably less than 30 mass %, and more preferably 0 to 20 mass % in the total monomer components.

Preferred olefins are α-olefin having 2 to 12 carbon atoms. Examples of the olefin include ethylene, propylene, 1-butene, isobutene, 1-pentene, 3-methyl-1-hexene, 1-octene, 1-octene, and 1-decene. In the polymerization of the polyolefin resin, one olefin may be used alone or in combination with two or more olefins.

As other monomers copolymerizable with olefins, for example, elastomer components having unsaturated bonds may be cited. Specific examples of other monomer include cyclic olefins such as cyclopentene and norbornene, and dienes such as 1,4-hexadiene and 5-ethylidene-2-norbornene. Further, monomers such as vinyl acetate, styrene, (meth)acrylic acid and its derivatives, vinyl ether, maleic anhydride, carbon monoxide, and N-vinylcarbazole may be used. One of the above other monomers may be used alone or in combination with two or more monomers in the polymerization of polyolefin resin. The term “(meth)acrylic acid” means at least one of acrylic acid or methacrylic acid.

Examples of the polyolefin resin include polyethylene resins mainly composed of ethylene such as high density polyethylene (HDPE), low density polyethylene (LDPE), and linear low density polyethylene (LLDPE); polypropylene resins mainly composed of propylene such as polypropylene (propylene homopolymer), ethylene-propylene copolymer, propylene-butene copolymer, ethylene-propylene-butene copolymer, and ethylene-propylene-diene copolymer, polybutene; and polypentene.

Specific examples of the polyolefin resin include, in addition, ethylene-vinyl acetate copolymer (EVA), ethylene-ethyl acrylate copolymer, polyketone, and copolymers produced with a metallocene catalyst. Also included are chemically reacted and modified compounds of these polymers, specifically ionomer resins, saponified EVA, and olefin elastomers produced using dynamic vulcanization in an extruder.

As the polyolefin resin, polyethylene-based resin and polypropylene-based resin are preferable, and polypropylene-based resin is more preferable. The stereo-regularity of the structure derived from propylene in polypropylene-based resins may be isotactic, syndiotactic, or atactic. As a polypropylene-based resin, isotactic polypropylene or a block type thereof is further preferred.

The polyolefin resin contained in the resin composition of the present invention may be one or more than one type. The polyolefin resins may be commercially available.

The content of the polyolefin resin in the resin composition of the present invention is the amount obtained by subtracting the contents of the above-mentioned component (A), component (B), component (C), and optionally other components from the resin composition. The content of the polyolefin resin in the total amount of the resin composition may be, for example, in the range of 20 to 90 mass %, and more preferably in the range of 30 to 80 mass %.

### (Other Resin)

The resin composition of the present invention may contain other resin than the polyolefin resin. Other resins are, for example, thermoplastic resins. Specific examples include polystyrene resins, acrylonitrile-butadiene-styrene copolymers (ABS resins), and polycarbonate resins and polyester resins such as polyethylene terephthalate. One or more of these may be used alone or in combination. As the other resin, a commercially available product may be used.

Further, as the other resin, a resin that functions as a toughening agent may be used. The toughening agent is used for the purpose of improving the flexibility, processability, and impact resistance, of the resin composition. For example, it is a resin having rubber elasticity. As mentioned above, the addition of a toughening agent is expected to reduce stiffness as a side effect. Therefore, when using the product, the content is preferably adjusted so as not to impair the effect of the present invention.

The resin used as a toughening agent is preferably an elastomer mainly composed of olefin-derived structural units such as ethylene propylene diene rubber (EPDM).

In addition to the above, thermoplastic elastomers may also be used, and it is particularly preferred that they contain olefin-derived constituent units. Examples of the thermoplastic elastomer include methyl methacrylate-butadiene-styrene copolymer (MBS), acrylonitrile-butadiene-styrene copolymer (ABS), styrene-butadiene-styrene copolymer (SBS), styrene-ethylene-butylene-styrene block copolymer (SEBS), ethylene-octene copolymer (EOR) and butyl acrylate-methyl methacrylate copolymers. Above all, it is preferable that the toughening agent is one or more selected from the group consisting of SEBS and EOR from the viewpoint of compatibility and flame retardancy of the resin composition and dispersibility of the thermoplastic elastomer in the resin composition. Among the toughening agents, those having the effect of imparting compatibility to the resin composition may also be used as a compatibilizer as described below. One type of toughening agent may be used alone or in combination with two or more types of toughening agents.

The content of other resin in the resin composition of the present invention is, for example, 0 to 20 parts by mass per 100 parts by mass of the polyolefin resin. More preferably, the range may be set to 0 to 10 parts by mass, and it is especially preferred that no other resin is included.

### (Component (A))

Component (A) is a phosphorus compound. In the resin composition of the present invention, component (A) acts primarily as a flame retardant. As described above, the phosphorus compound has a flame retardant effect by radical trapping and plasticization. In addition, component (A), together with the above effects, also acts to reduce the melt viscosity of the resin composition during molding, thereby improving the molding processability.

The content of component (A) is 0.05 to 2.5 mass % as the content of phosphorus to the total amount of the resin composition of the present invention. When the content of component (A), in terms of phosphorus content, is less than 0.05 mass %, the flame retardancy of the molded product is insufficient, and when it exceeds 2.5 mass %, the mechanical strength (toughness and rigidity) of the molded product is not sufficient. The content of component (A) with respect to the total amount of the resin composition is preferably in the range of 0.1 to 1.5 mass %, more preferably in the range of 0.15 to 0.65 mass %, in terms of phosphorus content.

Since the phosphorus compound that is component (A) has poor compatibility with the polyolefin resin, it tends to separate during melting, and the separated material bleeds out and remains on the surface of the molded product, causing deterioration in appearance. When the phosphorus content to the total amount of the resin composition is 2.5 mass % or less, the deterioration in appearance caused by the bleed out of component (A) may be suppressed.

The phosphorus content (mass %) with respect to the total amount of the above resin composition may be determined using, for example, an energy dispersive X-ray fluorescence analyzer (e.g., JSX-1000S, JEOL Ltd.), a wavelength dispersive X-ray analyzer (ZSX Primus IV, Rigaku), or an inductively coupled plasma atomic emission spectrometric analyzer.

Examples of the phosphorus compound include metal or ammonium salts of phosphinic acid, phosphonic acid, and phosphoric acid; and esters of phosphine acid, phosphonic acid, and phosphoric acid. Among these, phosphate ester compounds (to be described in detail later) are preferred as component (A2) from the viewpoint of flame retardant effects.

Specific examples of the above-described salt include phosphinic acid metal salts, particularly aluminum phosphinate and zinc phosphinate; metal phosphonates, particularly aluminum phosphonate, calcium phosphonate, and zinc phosphonate. Further, examples thereof include hydrates of metal phosphonates, ammonium phosphate, and ammonium polyphosphate.

Examples of the phosphinate ester compound include dimethylphosphinic acid, methylethylphosphinic acid, methylpropylphosphinic acid, diethylphosphinic acid, dioctylphosphinic acid, phenylphosphinic acid, diethylphenylphosphinic acid, diphenylphosphinic acid and bis(4-methoxyphenyl)phosphinic acid.

Examples of the phosphonate ester compound include methylphosphonic acid, dimethyl methylphosphonate, diethyl methylphosphonate, ethylphosphonic acid, propylphosphonic acid, butylphosphonic acid, 2-methyl-propylphosphonic acid, t-butylphosphonic acid, and 2,3-dimethylbutylphosphonic acid, octylphosphonic acid, phenylphosphonic acid, and dioctyl phenylphosphonate.

As the phosphorus compound other than the above, the following compounds may be used as component (A). Examples thereof include 9,10-dihydro-9-oxa-10-phosphaphenanthrene 10-oxide (DOPO) derivatives, polyphosphonates (Nofia™ HM1100, manufactured by FRX Polymers, Chelmsford, USA), zinc bis(diethyl phosphinate), aluminum tris(diethyl phosphinate), melamine phosphate, melamine pyrophosphate, melamine polyphosphate, melamine poly(aluminum phosphate), melamine poly(zinc phosphate), methylphosphonate melamine salt, guanylurea phosphate, guanidine phosphate, ethylenediamine phosphate, and phosphazene compounds such as phenoxyphosphazene oligomers.

One of these phosphorus compounds may be used alone as component (A), or two or more may be used in combination.

### [Phosphate Ester Compound]

The phosphate ester compound may be an aliphatic phosphate ester compound or an aromatic phosphate ester compound, with aromatic phosphate ester compounds being preferred. When an aromatic phosphate ester compound is used as component (A), kneading and molding may be performed at lower temperatures and with lower shear. It may be prevented the endothermic inorganic filler from undergoing thermal decomposition, which is an endothermic reaction, during kneading and molding, reducing the endothermic effect during combustion. Thereby, the flame retardant effect is more easily demonstrated.

The phosphate ester compounds include monomeric phosphate ester compounds obtained by reacting phosphoric acid with an aliphatic or an aromatic alcohol, and aromatic condensed phosphate ester compounds, which are reaction products of phosphorus oxychloride with a divalent phenolic compound and phenol (or an alkyl phenol).

Specific examples of the phosphate ester compound include trimethyl phosphate (TMP), triethyl phosphate (TEP), tributyl phosphate, triphenyl phosphate (TPP), tricresyl phosphate (TCP), trixylenyl phosphate (TXP), cresyldiphenyl phosphate (CDP), tris(2,4-di-t-butylphenyl) phosphate, distearyl pentaerythritol diphosphate, bis(2,6-di-t-butyl-4-methylphenyl)pentaerythritol diphosphate, bis(2,4-di-t-butylphenyl)pentaerythitol diphosphate, resorcinol bis-dixylenyl phosphate, resorcinol bis-diphenyl phosphate, bisphenol A bis-diphenyl phosphate (BADP), bisphenol A bis-dicresyl phosphate, bisphenol A bis-diphenyl phosphate, and bisphenol A bis-dixylenyl phosphate.

The phosphate ester compound is preferably a condensed phosphate ester compound, which is a condensation type, from the viewpoint of heat resistance. Examples of the condensed phosphate compound include aromatic condensed phosphate ester compounds represented by the following chemical formula (A2).

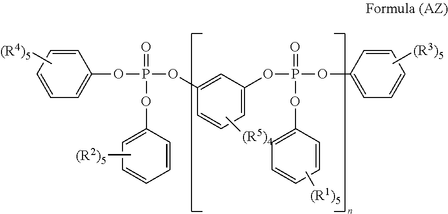

In the above Formula (A2), R¹ to R⁵ each independently represent a hydrogen atom, an alkyl group having carbon atoms of 1 to 10, a cycloalkyl group having carbon atoms of 3 to 20, an aryl group having carbon atoms of 6 to 20, or an alkoxy group having carbon atoms of 1 to 10, and R¹ to R⁵ may be the same or different. The plurality (5) of R¹ present may be identical or different from each other. The same is true for R², R³, R⁴ and R⁵ present in plurality (4 to 5), respectively, n is an integer of 1 to 30, preferably n is an integer of 1 to 10.

Examples of the alkyl group include a methyl group, an ethyl group, a propyl group, an isopropyl group, a butyl group, an isobutyl group, a sec-butyl group, a tert-butyl group, an amyl group, a tert-amyl group, a hexyl group and a 2-ethylhexyl group, an n-octyl group, a nonyl group, and a decyl group.

Examples of the cycloalkyl group include a cyclohexyl group. Examples of the aryl group include a phenyl group, a cresyl group, a xylyl group, a 2,6-xylyl group, a 2,4,6-trimethylphenyl group, a butylphenyl group, and a nonylphenyl group.

Examples of the alkoxy group include a methoxy group, an ethoxy group, a propoxy group, and a butoxy group.

An aromatic condensed phosphate ester compound is a reaction product of phosphorus oxychloride, a divalent phenolic compound and phenol (or alkylphenol) as described above, and an aromatic condensed phosphate ester compound whose structure is represented by Formula (A2) is a compound when the divalent phenolic compound is resorcinol which may have a substituent (hereinafter, also referred to as a “resorcinol compound”). The aromatic condensed phosphate ester compound may be a compound obtained by using 4,4′-biphenol and bisphenol A (each may have a substituent) instead of the resorcinol compound. Specifically, in Formula (A2), an aromatic condensed phosphate ester compound having a 4,4′-biphenol residue or a bisphenol A residue, each of which may have a substituent, instead of the resorcinol compound residue, may be used in the present invention.

The phosphate ester compound may be a commercially available product. Examples of the commercially available phosphate ester compound include PX-200 (resorcinol bis-dixylenyl phosphate), and CR-733S (resorcinol bis-diphenyl phosphate), and CR-741 (bisphenol A bis(diphenyl phosphate), all manufactured by Daihachi Chemical Industry Co., Ltd.

### (Component (B))

Component (B) is a NOR type HALS. The content of component (B) is 0.05 to 3 mass % of the total amount of the resin composition of the present invention. As described above, component (B) has flame retardant effects such as radical trapping and reduction in molecular weight during combustion.

When the content of component (B) is less than 0.05 mass %, the flame retardancy of the molded product is not sufficient, and when the content exceeds 3 mass %, the cost increase is significant. The content of component (B) with respect to the total amount of the resin composition is preferably in the range of 0.1 to 2 mass %, and the range of 0.2 to 1 mass % is more preferred.

The NOR-type HALS that is component (B) is a well-known light stabilizer. The addition of the NOR-type HALS, may impart light resistance to a molded product.

The NOR-type HALS is a HALS (hindered amine light stabilizer) having an alkoxyimino group (>N—(OR). The NOR-type HALS has a structure of an N-alkoxy group which is made by replacing H in the NH portion of the imino group (>NH) with an alkoxy group. On the other hand, in the NH-type HALS, H in the NH portion of the imino group remains as H, and in the NR-type HALS, H in the NH portion of the imino group is replaced with an alkyl group R (same meaning as R in the alkoxy group), typically replaces with a methyl group. This N-alkoxy group traps alkyl peroxy radicals (RO₂), which readily become radicals and exhibits flame retardant effects. In addition, in the resin composition of the present invention, it also functions as a light stabilizer as described above.

On the other hand, in the case of N-methyl-type hindered amine compounds or NH-type hindered amine compounds, the flame retardant effect is also low.

R in the above alkoxy group (—OR) represents a substituted or unsubstituted saturated or unsaturated hydrocarbon group. Examples of R include an alkyl group, an aralkyl group, and an aryl group. The alkyl group may be linear, branched-chain or cyclic, or a combination of these.

The NOR-type HALS used in the present invention is not particularly limited as long as it has an alkoxyimino group (>N—OR) structure. Specific suitable examples thereof include the NOR-type HALS described in JP-A 2002-507238, WO 2005/082852, and WO 2008/003605.

Examples of the NOR-type HALS include compounds having a structure represented by the following formula (B). When halogen-containing substances remain as impurities, they may be appropriately purified and used.

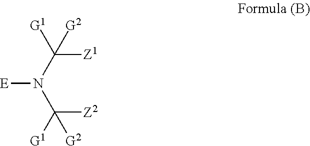

In Formula (B), G¹ and G² independently represent an alkyl group having 1 to 4 carbon atoms or a pentamethylene group by combining together. Z¹ and Z² each represent a methyl group, or Z¹ and Z² forma crosslinked moiety by combining together. The crosslinked moiety may be further attached to an organic group via an ester group, an ether group, an amide group, an amino group, a carbonyl group or a urethane group. E represents an alkoxy group having 1 to 18 carbon atoms, a cycloalkoxy group having 5 to 12 carbon atoms, an aralkoxy group having 7 to 25 carbon atoms, or an aryloxy group having 6 to 12 carbon atoms.

As the NOR-type HALS represented by Formula (B), from the viewpoint of flame retardancy and heat resistance, a structure containing a plurality of alkoxyimino groups is preferred.

Further, as the NOR-type HALS represented by Formula (B), for example, a compound represented by the following Formula (1) may be used.

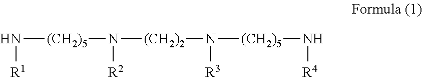

In Formula (1), R¹ to R⁴ each respectively represent a hydrogen atom or an organic group of Formula (2) below. At least one of R¹ to R⁴ represents an organic group of Formula (2) below.

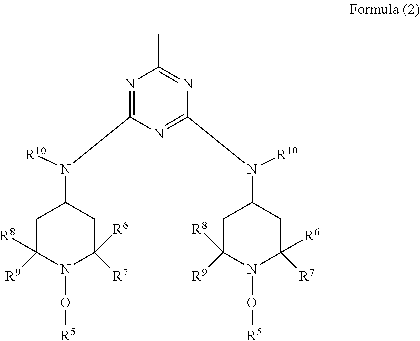

In the formula, R⁵ represents an alkyl group having 1 to 17 carbon atoms, a cycloalkyl group having 5 to 10 carbon atoms, a phenyl group or a phenylalkyl group having 7 to 15 carbon atoms. R⁶, R⁷, R⁸ and R⁹ each represent an alkyl group having 1 to 4 carbon atoms. R¹⁰ represents a hydrogen atom or a linear or branched-chain alkyl group having 1 to 12 carbon atoms.

Among the alkyl groups having 1 to 17 carbon atoms which are represented by R⁵, a methyl group, a propyl group or an octyl group is preferable. Among the cycloalkyl groups having 5 to 10 carbon atoms, a cyclohexyl group is preferable. Among the phenyl group or phenylalkyl groups having 7 to 15 carbon atoms, a phenyl group is preferable.

Among the alkyl groups having 1 to 4 carbon atoms which are represented R⁶ to R⁹, a methyl group is preferable. Among the linear or branched-chain alkyl groups having 1 to 12 carbon atoms which are represented by R¹⁰, an n-butyl group is preferable.

In the compounds represented by Formula (1), those in which R¹, R², and R³ are an organic group of Formula (2), or those in which R¹, R², and R⁴ are an organic group of Formula (2) are preferable.

Examples of the NOR-type HALS include the following compounds: 1-cyclohexyloxy-2,2,6,6-tetramethyl4-octadecylaminopiperidine; bis(1-octyloxy-2,2,6,6-tetramethylpiperidine-4-yl) sebacate; 2,4-bis[(1-cyclohexyloxy-2,2,6,6-tetramethylpiperidine-4-yl) butylamino]-6-(2-hydroxyethylamino)-s-triazine; bis(1-cyclohexyloxy-2,2,6,6-tetramethylpiperidin-4-yl) adipate; an oligomer compound that is a condensation product of 4,4′-hexamethylenebis(amino-2,2,6,6-tetramethylpiperidine) with 2-chloro-4,6-bis(dibutylamino)-s-triazine-terminated 2,4-dichloro-6-[(1-octyloxy-2,2,6,6-tetramethylpiperidine-4)-yl)butylamino]-s−triazine; an oligomer compound that is a condensation product of 4,4′-hexamethylenebis(amino-2,2,6,6-tetramethylpiperidine) with 2-chloro-4,6-bis(dibutylamino)-s-triazine-terminated 2,4-dichloro-6-[(1-cyclohexyloxy-2,2,6,6-tetramethylpiperidine-4)-yl)butylamino]-s-triazine; 2,4-bis[(1-cyclohexyloxy-2,2,6,6-piperidine-4-yl)-6-chloro-s-triazine; a reaction product of peroxidized 4-butylamino-2,2,6,6-tetramethylpiperidine with 2,4,6-trichloro-s-triazine, cyclohexane, and N, N′-ethane-1,2-diylbis(1,3-propanediamine) (N, N′, N′″-tris{2,4-bis[(1-cyclohexyloxy-2,2,6,6-tetramethylpiperidine-4-yl) n-butylamino]-s-triazine-6-yl}-3,3′-ethylenediiminodipropylamine); bis(1-undecanoxy-2,2,6,6-tetramethylpiperidine-4-yl) carbonate; 1-undecyloxy-2,2,6,6-tetramethylpiperidine-4-one; and bis(1-stearyloxy-2,2,6,6-tetramethylpiperidine-4-yl) carbonate.

A commercially available product may be used for the NOR-type HALS. Examples of the commercially available NOR-type HALS include Flamestab NOR116FF, NOR116FF, TINUVIN NOR371, TINUVIN XT 850FF, TINUVIN XT 855FF, and TINUVIN PA 123 (manufactured by BASF Corporation); and LA-81 and FP-T (manufactured by ADEKA, Inc.). The NOR-type HALS may be used alone or in combination with two or more types.

### (Component (C))

Component (C) is an inorganic filler satisfying the requirements of (1) and (2).
(1) The DTA curve obtained by differential thermal analysis has an endothermic portion in the temperature range of 180 to 500° C.
(2) The ratio value of the number of particles having a maximum diameter of 300 μm or more to the number of particles having a maximum diameter of 100 μm or more is ⅕ or less, or there are no particles having a maximum diameter of 100 μm or more.

In (1), the term “to have an endothermic portion” means that the DTA curve has an endothermic portion in the temperature range from 180 to 500° C. with respect to the baseline of the DTA curve. For example, if the starting region of the endothermic peak exists in the vicinity of 500° C. at a lower temperature than 500° C., it is said “to have an endothermic portion”. If the end region of the endothermic peak exists in the vicinity of 180° C. on the higher side than 180° C., it is said “to have an endothermic portion”.

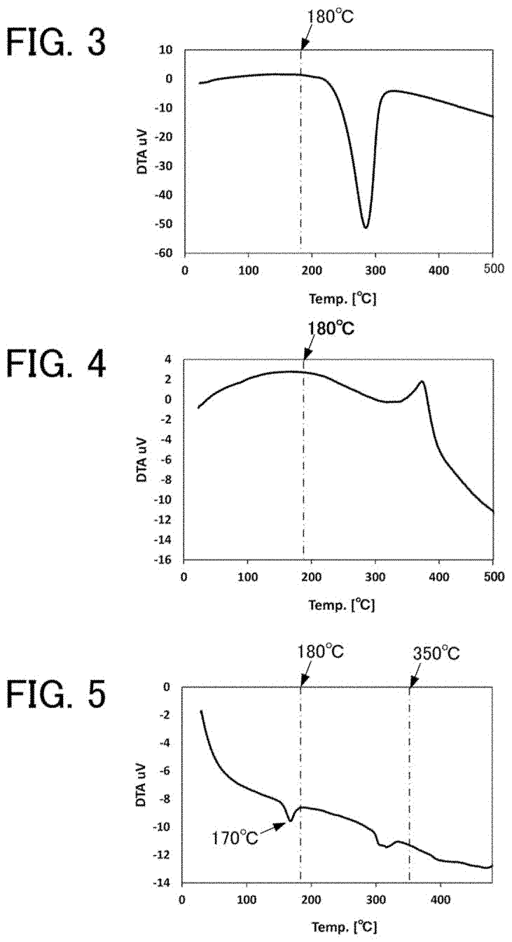

FIG. 3 shows a DTA curve satisfying (1). FIG. 3 shows a DTA curve for the aluminum hydroxide particles (KH-101) used in Example. In FIG. 3, an endothermic portion (entire endothermic peak) is shown at 220 to 320° C.

FIG. 4 shows a DTA curve that does not satisfy (1). FIG. 4 is a DTA curve for the calcium carbonate particles (CALCEEDS P) used in the example. In FIG. 4, it can be seen that there is no endothermic portion between 180 and 500° C. CALCEEDES P is calcium carbonate particles surface-modified with a fatty acid, and the DTA curve in FIG. 4 has an exothermic peak with a maximum value around 370° C. This exothermic peak is presumably due to the thermal decomposition of the surface modifier in CALCEEDS P. In the absence of surface modification, the DTA curve of calcium carbonate particles typically shows no endothermic or exothermic portion in 180 to 500° C.

Differential thermal analysis is performed using a differential thermal analyzer such as DTG-60A (Shimadzu Corporation, simultaneous differential thermal/thermogravimetric analyzer). For example, the temperature is increased at 10° C./minute in a N₂ gas atmosphere.

Even in the case of a mixture of an endothermic inorganic filler (component (C1)) and a non-endothermic inorganic filler (component (C2)), which is described below, the component (C) has a DTA curve showing an endothermic portion derived from component (C1).

In (2), the maximum diameter of the inorganic filler is measured by observing the resin composition with a scanning electron microscope, such as JSM-7401F (manufactured by JEOL Ltd.) with an appropriately adjusted magnification. Herein, the “maximum diameter of particles” is the maximum diameter of primary particles when the inorganic filler exists in the resin composition in the state of primary particles, and the maximum diameter of agglomerated particles when it exists in the state of agglomerated particles. Specifically, in the image of the particles to be measured (primary particles or agglomerated particles) observed with a scanning electron microscope, the maximum diameter of the particles is the largest length obtained by connecting two points of the contour of the particle with a straight line.

The number of particles having a maximum diameter of 100 μm or more and the number of particles having a maximum diameter of 300 μm or more may be counted, for example, in a viewing area of a predetermined size, for example, 480 μm×360 μm, which is obtained by photographing the resin composition at a magnification of 300 times using a scanning electron microscope.

The viewing area of 480 μm×360 μm is, for example, four times the size (240 μm×180 μm) that may be obtained in one image when photographed at a magnification of 300 times (twice both vertically and horizontally). The area is divided into 4 images (2 vertical×2 horizontal=4 images), and the number of particles having the maximum diameter is counted as the viewing area of the above size.

Further, for example, the number of particles having a maximum diameter of 100 μm or more and the number of particles having a maximum diameter of 300 μm or more measured in images taken by randomly selecting 10 viewing areas of the above size may be used for obtaining an average value. The image analysis in (2) above may be performed using an image analysis software ImageJ.

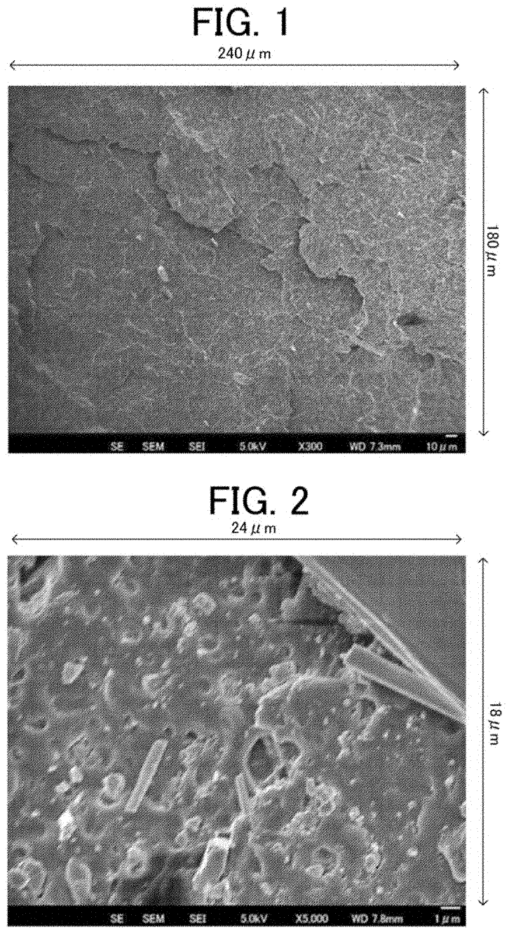

FIG. 1 shows an image (240 μm×180 μm) of the cross section of the resin composition obtained in Example 1 taken with an electron microscope (300 times). The image shown in FIG. 1 is one of four images taken by dividing the viewing area of the size of 480 μm×360 μm into four parts. Here, in the image shown in FIG. 1, there are no particles having a maximum diameter of 300 μm or more and no particles having a maximum diameter of 100 μm or more. Similarly, for the remaining three images, the number of particles having a maximum diameter of 300 μm or more, and the number of particles having a maximum diameter of 100 μm or more are counted. The value of the ratio of the number of particles having a maximum diameter of 300 μm or more to the number of particles having a maximum diameter of 100 μm or more is obtained from the total of four sheets.

In the above method, 10 viewing areas of 480 μm×360 μm size are randomly selected and photographed by electron microscope (300 times). The number of particles is counted in the same way as above, and the maximum number of particles in the 480 μm×360 μm size viewing area is calculated. The ratio value of the number of particles having a maximum diameter of 300 μm or more to the number of particles having a maximum diameter of 100 μm or more in a viewing area of 480 μm×360 μm is obtained. The average of the ratio values for the 10 locations is the ratio value in (2). The presence or absence of particles having a maximum diameter of 100 μm or more may also be checked in the same way.

The viewing area for counting the number of particles having a maximum diameter of 100 μm or more and the number of particles having a maximum diameter of 300 μm or more is not limited to the above 480 μm×360 μm as long as the number of particles of these sizes can be counted. It is possible to change the size of the viewing area appropriately.

The resin composition used for taking photographs was observed, for example, at any part of a pellet of the resin composition obtained by melt-kneading or at a fractured surface of a molded body, where there is a distance of 1 mm or more from the topmost surface to the center of the molded body. The size, shape, and dispersion state of the particles of the inorganic filler in the resin composition are retained after the resin composition becomes a molded body.

By satisfying (1), component (C) may provide the molded product with a flame retardant effect due to heat absorption that is not shown by component (A) and component (B). Also, by satisfying (2), component (C) may improve the mechanical strength of the molded product while keeping small the effect of suppressing the drip during combustion of the molded product.

The content of component (C) is 5 to 50 mass % of the total amount of the resin composition of the present invention. When the content of component (C) is less than 5 mass %, the flame retardancy of the molded product is not sufficient, and when the content exceeds 50 mass %, the content of the polyolefin resin becomes relatively low and the characteristics of the polyolefin resin are impaired. The content of component (C) with respect to the total amount of the resin composition is preferably in the range of 10 to 30 mass %, and the range of 15 to 25 mass5 is more preferred.

Component (C) contains at least an endothermic inorganic filler (hereinafter also referred to as an “endothermic inorganic filler (C1)”) that satisfies the requirements of (1). In order to keep the particle size of the inorganic filler within a predetermined range, component (C) may further contain a non-endothermic inorganic filler (hereinafter also referred to as a “non-endothermic inorganic filler (C2)”) that does not have an endothermic portion in the temperature range of 180 to 500° C. in the DTA curve obtained by differential thermal analysis.

The endothermic inorganic filler (C1) is not particularly restricted as long as the particles are composed of a material satisfying the requirement in (1), for example. Specific examples include aluminum hydroxide particles, boehmite particles, magnesium hydroxide particles, and hydromagnesite particles. One of these may be used alone, or two or more may be used in combination.

Examples of the non-endothermic inorganic filler (C2) include wollastonite particles, talc particles, mica particles, glass particles, kaolin particles, magnesium sulfate particles, calcium carbonate particles, and silica particles. One of these may be used alone, or two or more may be used in combination.

In the endothermic inorganic filler (C1) and non-endothermic inorganic filler (C2), the shape of the particles is not particularly restricted. Examples of the shape includes spherical, spindle, plate, scale, needle, and fibrous.

In the endothermic inorganic filler (C1) and non-endothermic inorganic filler (C2), the particles may be surface modified with a surface modifier if necessary. Examples of the surface modifier that may be used for surface modification include alkylsilazane compounds such as hexamethyldisilazane (HMDS), dimethyldimethoxysilane, dimethyldiethoxysilane, and alkylalkoxysilanes such as trimethylmethoxysilane, methyltrimethoxysilane, and butyltrimethoxysilane, chlorosilanes such as dimethyldichlorosilane and trimethylchlorsilane, silicone oil, silicone varnish, and various fatty acids. One of these surface modifiers may be used alone, or a mixture of two or more may be used.

As described above, when the inorganic filler particles are surface-modified with an organic compound as exemplified above, an exothermic peak due to the organic compound may be observed in the range of 180 to 500° C. in the DTA curve. When particles made of various inorganic materials exemplified for the endothermic inorganic filler (C1) have an exothermic portion (exothermic peak) due to, for example, surface modifier in the range of 180 to 500° C. of the DTA curve, the inorganic filler can be an endothermic inorganic filler (C1) as long as the endothermic portion is at least a part of it.

The content of the endothermic inorganic filler (C1) in component (C) is preferably in the range of 10 to 100 mass %, more preferably in the range of 50 to 100 mass %, and still more preferably in the range of 80 to 100 mass % with respect to the total amount of component (C). The content of the endothermic inorganic filler (C1) with respect to the total amount of the resin composition of the present invention is preferably 3 mass % or more. The content ratio of the non-endothermic inorganic filler (C2) is the remainder after subtracting the content of the heat-absorbing inorganic filler (C1) from the total amount of the component (C).

The requirement (2) in component (C) is a requirement specifying the maximum particle size, and is a requirement for a mixture of an endothermic inorganic filler (C1) and a non-endothermic inorganic filler (C2). That is a requirement for component (C).

Component (C) is further preferred to satisfy the requirements of (a) or (b) below.
(a) A ratio value of a number of particles having a maximum diameter of 200 μm or more to a number of particles having a maximum diameter of 100 μm or more is 1/10 or less, or there are no particles having a maximum diameter of 100 μm or more, and a ratio value of a number of particles having a maximum diameter of less than 5 μm to a number of particles having a maximum diameter of 5 μm or more is 10 or more.
(b) There are no particles having a maximum diameter of 5 μm or more.

Here, the requirement in (a) may be divided into the following requirements (3) and (4).
(3) A ratio value of a number of particles having a maximum diameter of 200 μm or more to a number of particles having a maximum diameter of 100 μm or more is 1/10 or less, or there are no particles having a maximum diameter of 100 μm or more.
(4) A ratio value of a number of particles having a maximum diameter of less than 5 μm to a number of particles having a maximum diameter of 5 μm or more is 10 or more.

For (3) above, the same measurement method as (2) may be applied. For (4) and (b) above, the following method may be applied.

The number of particles having a maximum diameter of less than 5 μm and the number of particles having a maximum diameter of 5 μm or more may be counted in a viewing area of a predetermined size, for example, a size of 20 μm×15 μm of the resin composition photographed with a scanning electron microscopy at a magnification of 5000 times. The viewing area of 20 μm×15 μm is, for example, a size that may be acquired in one image when photographed at a magnification of 5000 times. In order to obtain the ratio value in (4), 10 locations are randomly selected from the cross section of the resin composition, and the number of particles of each maximum diameter is calculated using an image (24 μm×18 μm) with a magnification of 5000 times. Then, the average value of 10 points is defined as the number of particles having a maximum diameter of less than 5 μm and the number of particles having a maximum diameter of 5 μm or more.

FIG. 2 shows an image of a cross section of the resin composition obtained in Example 1 taken with an electron microscope (5000 times). The number of particles having a maximum diameter of less than 5 μm counted in the image is 141. The number of particles having a maximum diameter of 5 μm or more is 3. Here, for particles having a maximum diameter of 5 μm or more, in addition to particles whose entire image is photographed in the 24 μm×18 μm image, particles partially photographed are also counted as particles having a maximum diameter of 5 μm or more. In the above method, the number of particles is counted in the same way using 10 images of the same magnification, the average value is obtained, and the ratio value in (4) is calculated using that value. The presence or absence of particles having a maximum diameter of 5 μm or more in (b) may also be checked in the same manner.

The viewing area for counting the number of particles having a maximum diameter of less than 5 μm and the number of particles having a maximum diameter of 5 μm or more is not limited to the above size of 24 μm×18 μm. The size of the viewing area may be changed as needed.

The image analysis in (3) and (4) above may be performed using an image analysis software ImageJ.

In the requirement of (2) above, a ratio value of 1/10 or less is more preferred, and 1/50 or less is even more preferred. When there are no particles having a maximum diameter of 100 μm or more, both the denominator and the numerator are set to “0” and the ratio value is set to “0”.

In the requirement of (3) above, a ratio value of 1/50 or less is more preferred, and 1/80 or less is even more preferred. When there are no particles having a maximum diameter of 100 μm or more, both the denominator and the numerator are set to “0” and the ratio value is set to “0”.

In the requirement in (4) above, a ratio value of 30 or more is more preferred, and 50 or more is even more preferred. When there are particles having a maximum diameter of less than 5 μm and no particles having a maximum diameter of 5 μm or more, only the denominator is “0” and the ratio value is considered infinite.

By satisfying the requirement of (3) in addition to (2), the rigidity may be improved by the inorganic filler having a large maximum diameter. Although inorganic fillers having a large maximum diameter may reduce flame retardancy and toughness, by satisfying (2) or (3), flame retardancy may be compensated to a practical level by endothermic inorganic fillers, NOR-type hindered amine and phosphorus compounds. In addition, the degradation of toughness may be kept within the practical level. Furthermore, by satisfying the requirement (4), the toughness may be improved by the inorganic filler having a small maximum diameter, and the balance of flame retardancy, rigidity, and toughness may be improved.

Satisfying the requirement in (b) has the same effect as satisfying the requirements in (3) and (4) above.

### (Other Additives)

The resin composition of the present invention may contain, in addition to the above-mentioned resin including a polyolefin resin, component (A), component (B) and component (C), other components known as additives to the extent not impairing the effect of the present invention. Other additives include other flame retardants, crystal nucleating agents, dispersing agents, antioxidants, lubricants, compatibilizers other than component (A), component (B) and component (C).

### <Other Flame Retardants>

Other flame retardants include organic or inorganic flame retardants other than component (A), component (B) and component (C) that do not contain halogen atoms. Examples of inorganic flame retardants include silicone compounds.

### <Crystal Nucleating Agent>

As crystal nucleating agents, sorbitols, rosins, and petroleum resins may be cited, although there is no particular limitation.

Specific examples of the crystal nucleating agent include sorbitols such as alkyl-substituted benzylidene sorbitol (e.g., 1,3,2,4-dibenzylidene sorbitol, 1,3,2,4-di-(p-methylbenzylidene)sorbitol, 1,3-o-methylbenzylidene-2,4-p-methylbenzylidene sorbitol, 1,3,2,4-di-(p-ethylbenzylidene)sorbitol, and 1,3,2,4-di-(2′,4′-dimethylbenzylidene)sorbitol), sodium benzoate, aluminum p-t-butylbenzoate, sodium montanoate, and calcium montanoate. One of these may be used alone, or a combination of two or more may be used.

A commercially available crystal nucleating agent may be used. Examples of the commercially available crystal nucleating agent include NJSTAR NU-100 (product name, manufactured by New Japan Chemical Co., Ltd.).

### <Antioxidant>

Examples of the antioxidant include hindered phenols.

### <Dispersing Agent>

Examples of the dispersing agent include fatty acids or their salts, fatty acid esters, fatty acid amides, higher alcohols, hydrogenated oils, silane coupling agents, and alcohol phosphate esters. Fatty acids or their salts are preferred. One of these dispersing agents may be used alone, or two or more may be used in combination. The dispersing agent improves the dispersibility of component (C) to the polyolefin resin in the resin composition. Many of the dispersing agents also function as the following lubricants.

As fatty acids, higher fatty acids are preferred, such as stearic acid, oleic acid, palmitic acid, linoleic acid, lauric acid, caprylic acid, behenic acid, and montanic acid. As salts of fatty acids, metal salts of the above higher fatty acids are preferred. Examples thereof include stearic acid salts, oleic acid salts, palmitic acid salts, linoleic acid salts, lauric acid salts, caprylic acid salts, behenic acid salts, montanic acid salts. The metal types include Li, Na, K, Al, Ca, Mg, Mg, Zn, and Ba.

### <Lubricant>

Examples of the lubricant include a fatty acid salt, a fatty acid amide, a silane polymer, a solid paraffin, a liquid paraffin, calcium stearate, zinc stearate, stearic acid amide, silicone powder, methylene bisstearic acid amide and N,N′-ethylene bisstearic acid amide. One or more of these may be selected.

### <Compatibilizer>

A compatibilizer is used to adjust the interfacial strength of the polyolefin resin and component (C). As a compatibilizer, specifically, one having the same structure or a compatible structure with the polyolefin resin and containing a moiety having affinity with component (C) in a part of the molecule is preferred. The moieties having affinity with component (C) include a carboxy group, a carboxylic anhydride residue, and a carboxylic acid ester residue. As a moiety having an affinity with component (C), it is preferred to include a carboxylic anhydride residue from the viewpoint of the upper temperature limit during the molding process. Maleic anhydride and citric anhydride are examples of a carboxylic acid anhydride residue, and a maleic anhydride residue is particularly preferred.

The compatibilizer is preferably a maleic anhydride modified version of a polyolefin resin. Examples of the compatibilizer include SEBS (styrene-ethylene-butylene-styrene block copolymer), MAH-PP (maleic anhydride-grafted polypropylene), and CEBC (ethylene-ethylene-butylene-ethylene block copolymer).

Commercial available products may be used as a compatibilizer. Commercially available maleic anhydride modified polyolefin resins include MG-441P (product name, manufactured by Riken Vitamin Co., Ltd.), as a maleic anhydride modified polypropylene resin, HE810 (product name, manufactured by Mitsui Chemicals, Inc.), and as SEBS, TUFTEC M1911 (product name, Asahi Kasei Chemical Co., Ltd.).

The content of the other additive in the resin composition of the present invention is within the range in which the effect of the present invention is not impaired, and for example, it is in the range of 0.1 to 30 mass % of the total amount of the resin composition. A range of 0.1 to 20 mass % is preferred. In total, 30 mass % or less is preferred.

### [Method for Producing Resin Composition]

The resin composition of the present invention is obtained by melt-kneading the raw material components of the resin including the polyolefin resin above, component (A), component (B), component (C), and other additives which may be included as required, so as to become the resin composition of the present invention described above. The method of melt-kneading is not particularly limited, and any known melt-kneading method may be used.

Melt-kneading is performed, for example, using kneading devices such as a Banbury mixer, a roll mixer, a Plastograph, an extruder (single-screw extruder, a multi-screw extruder (for example, a twin-screw extruder)), and a kneader. Among these, melt-kneading using an extruder is preferred because of its high production efficiency. Furthermore, it is preferable to use a multi-screw extruder for melt-kneading because of its ability to impart high shear properties, and it is more preferable to use a twin-screw extruder. The term extruder is used here in the category including extrusion kneading machines.

The temperature during melt-kneading (melt-kneading temperature) is set to be higher than the melting temperature of the polyolefin resin. For example, a melt-kneading temperature of 150 to 280° C. is preferred, and it is selected as appropriate depending on the polyolefin resin to be used. When a polypropylene-based resin is used as the polyolefin resin, a melt-kneading temperature of 170 to 250° C. is preferred. More preferably, the temperature is 170 to 230° C. When an extruder is used for melt-kneading, the melt-kneading temperature corresponds to the cylinder temperature.

When an extruder is used for melt-kneading, the screw speed is preferably in the range of 50 to 300 rpm. The discharge rate of the resin composition from the extruder is preferably in the range of 1 to 50 kg/hr.

In the present invention, if necessary, components other than the resin including the polyolefin resin may be added in the middle of melt-kneading to adjust the time required for melt-kneading for each component. For example, in the case of adding component (C) in the middle of the melt-kneading, a twin-screw extruder is used, the raw material components other than component (C) are fed from a hopper installed at the very end of the cylinder of the twin-screw extruder, and component (C) is fed from a side feeder installed at the front of the cylinder, for example, at the center to produce a resin component. The foremost end of the cylinder is the discharge portion of the resin composition, and the rearmost portion corresponds to the vicinity of the end of the cylinder on the side opposite to the discharge portion. Instead of component (C), component (A) or component (B) may be supplied in the middle of the process.

By adding components other than the resin including the polyolefin resin during the melt-kneading, for example, in the case of component (C), the effect of suppressing breakage of the particles and maintaining the particle shape may be obtained. In particular, in the case of fibrous particles, the effect of suppressing breakage of the fibrous particles and maintaining a large fiber length of the fibrous particles is obtained.

Before melt-kneading, each component may be pre-mixed (dry blended) using various mixers such as, for example, a high-speed mixer known as a tumbler or a Henschel mixer.

In the above, after extruding the molten mixture in the form of strands from the discharge section of the extruder, the extruded molten mixture in the form of strands may be processed into pellets, flakes or other forms.

The resin composition may take various forms such as powder, granules, tablets, pellets, flakes, fibers, and liquid.

### <Physical Properties of Resin Composition>

The resin composition of the present invention preferably have an endothermic portion in the temperature range of 180 to 350° C. in the DTA curve obtained by differential thermal analysis under a temperature increase condition of 10° C./minute. By having an endothermic portion, it is possible to obtain an endothermic effect by the endothermic inorganic filler (C1) that exceeds the heat generated by the pyrolysis of the polyolefin resin in the matrix before or during combustion.

FIG. 5 shows a DTA curve obtained by differential thermal analysis of the resin composition obtained in Example 1. Differential thermal analysis is performed using a differential thermal analyzer such as DTG-60A (simultaneous differential thermal/thermogravimetric analyzer, Shimadzu Corporation). For example, the temperature is increased at 10° C./minute in a N₂ gas atmosphere.

The DTA curve shown in FIG. 3 indicates endothermic peaks around 160 to 180° C. and 295 to 330° C. The endothermic peak around 160 to 180° C. is assumed to be derived from the polyolefin resin in the matrix. The endothermic peak around 295 to 330° C. is assumed to be an endothermic peak due to the above endothermic inorganic filler (C1).

### (Molded Product)

The resin composition of the present invention may be used to produce a molded product. The molded product may provide a resin product having excellent mechanical properties of toughness and rigidity as well as flame retardancy. In producing the molded product, the resin composition is melted and molded in various molding machines. The molding method may be selected according to the form of the molded product and the application. For example, injection molding, extrusion molding, compression molding, blow molding, calendering, and inflation molding may be mentioned. The sheet or film-shaped molded product obtained by extrusion molding or calendering may also be subjected to secondary molding such as vacuum molding or pressure air molding.

The molded product molded from the resin composition of the present invention preferably has a flexural modulus as measured in a bending test conducted according to JIS-K7171 (ISO 178) of 1.2 GPa or more, more preferably 1.5 GPa or more, and still more preferably 1.8 GPa or more. When the flexural modulus is 1.2 GPa or more, it may be evaluated that the rigidity of the molded product is practically acceptable.

The molded product molded from the resin composition of the present invention preferably has a notched Charpy impact strength of 6 kJ/m² or more, for example, measured in a notched Charpy impact test conducted in accordance with JIS-K7111-1 (ISO 179-1). More preferably, it is 8 kJ/m² or more, and still more preferably, it is 10 kJ/m² or more. When the notched Charpy impact strength is 6 kJ/m² or more, the toughness of the molded product may be evaluated as being acceptable for practical use.

The molded product molded from the resin composition of the present invention preferably has an un-notched Charpy impact strength of 60 kJ/m² or more, for example, measured in an un-notched Charpy impact test conducted in accordance with JIS-K7111-1 (ISO 179-1). More preferably, it is 80 kJ/m² or more, and still more preferably, it is 90 kJ/m² or more, or not broken (hereinafter also indicated as “NB”). When the un-notched Charpy impact strength is 60 kJ/m² or more, the toughness of the molded product may be evaluated as being acceptable for practical use.

The flame retardancy of the molded product molded from the resin composition of the present invention may be evaluated, for example, by the following indicator. The term “flame retardancy” herein refers to resistance to catching fire. Although JIS, ASTM, and other standards are available for evaluating flame retardancy, in general, special emphasis is placed on the UL standard. The UL standard is a standard established and evaluated by the “Underwriters Laboratories” in the United States.

In a molded product molded from the resin composition of the present invention, when a test piece of a predetermined size is evaluated according to the above UL standard, it is preferable that the test piece is determined to be V-2 or higher, more preferably V-1 or higher, and even more preferably V-0 in a combustion test based on the UL94V test.

The average burning time in the UL94V test may also be used as an indicator. The average burning time may be measured by the following method. In a molded product molded from the resin composition of the present invention, when tested as a test piece of a predetermined size, an average combustion time of less than 30 seconds is preferred, 20 seconds or less is more preferred, and 10 seconds or less is still more preferred.

### [Measurement Method of Average Burning Time]

In the UL94V test (vertical combustion test), a flame is applied to the lower end of the test piece for 10 seconds and the time until extinguished (combustion time) is measured. The test is repeated twice on the same test piece with T1 being the combustion time at the first flame contact and T2 being the combustion time at the second flame contact. The average value (T1+T2)/2 is calculated as the burning time of the test piece. Five test pieces are prepared, the same test as described above is performed on the five test pieces, and the average value of the burning times of the five test pieces is taken as the average burning time.

The molded products molded from the resin composition of the present invention are not particularly limited. Examples thereof include electrical and electronic parts, electrical components, exterior parts, and interior parts in the fields of information equipment, home appliances and automobiles, as well as various packaging materials, household goods, office supplies, piping, and agricultural materials.

### EXAMPLES

Hereinafter, the present invention will be specifically described with reference to examples, but the present invention is not limited thereto. In addition, although the description of “parts” or “%” is used in the examples, it represents “parts by mass” or “mass %” unless otherwise specified.

### Resin Compositions: Examples 1 to 18, Comparative Examples 1 to 6

The following commercial products were prepared as raw material components to be included in the resin compositions of each of Examples and Comparative Examples.

### <Resin>

Polypropylene resin: Prime Polypro J715M (product name, manufactured by Prime Polymer Co., Ltd.)

Polyethylene resin: HJ560 (product name, manufactured by Japan Polyethylene Corporation)

### <Component (A)>

Phosphate ester compound 1: PX-200 (product name, manufactured by Daihachi Chemical Industry Co. Ltd., Resorcinol bis-dixylenyl phosphate)

Phosphate ester compound 2: CR-741 (product name, manufactured by Daihachi Chemical Industry Co. Ltd., Bisphenol A bis(diphenyl phosphate))

### <Component (B)>

NOR-type hindered amine 1: Flamestab NOR116FF (product name, BASF Corporation, N,N′,N′″-tris{2,4-bis[(1-cyclohexyloxy-2,2,6,6-tetramethylpiperidin-4-yl)-n-butylamino]-s-triazine-6-yl}-3,3′-ethylenediiminodipropylamine) NOR-type hindered amine 2: TINUVIN NOR371FF (product name, BASF Corporation, 1,6-Hexanediamine, N1,N6-bis(2,2,6,6-tetramethyl-4-piperidinyl)-, polymer with 2,4,6-trichloro-1,3,5-triazine, reaction products with 3-bromo-1-propene, N-butyl-1-butanamine and N-butyl-2,2,6,6-tetramethyl4-piperidinamine, oxidized, hydrogenated)

### <Component (C)>

### <Component (C1); Endothermic Inorganic Filler>

Aluminum hydroxide particles: KH-101 (product name, manufactured by KC Corporation, particles having an average primary particle size of 1.0 μm)

FIG. 3 shows a DTA curve of KH-10 measured by a differential thermal analyzer (DTG-60A, Shimadzu, Inc., N₂ gas atmosphere, temperature increase condition: 10° C./min).

Magnesium hydroxide particles: MAGSEEDS N-6 (product name, manufactured by Konoshima Chemical Industry Co. Ltd., particles having an average primary particle size of 1.2 μm and modified with a higher fatty acid)

Each of the above-mentioned inorganic fillers as component (C1) has a DTA curve obtained by differential thermal analysis as shown in FIG. 3, for example. It has been confirmed that the DTA curve has an endothermic portion in the temperature range of 180 to 500° C.

### <Component (C2); Non-Endothermic Inorganic Filler>

Wollastonite particle 1: NYGLOS8 (product name: manufactured by IMERYS S.A., average primary particle size: fiber length 156 μm×fiber diameter 12 μm)

Wollastonite particle 2: NYGLOS4W (product name, manufactured by IMERYS S.A., average primary particle size: fiber length 63 μm×fiber diameter 7 μm)

Calcium carbonate particles: CALCEEDS P (product name, manufactured by Konoshima Chemical Industry Co. Ltd., an average primary particle size: 0.2 sin, and surface-modified with a fatty acid)

FIG. 4 shows a DTA curve of CALCEEDS P measured by a differential thermal analyzer (DTG-60A, Shimadzu, Inc., under a N₂ gas atmosphere, temperature increase condition: 10° C./min).

Mica particles: Suzorite 350-P0 (product name, average primary particle size: 25 μm in median diameter)

Talc particles: Micro Ace P3-RC (product name, manufactured by Japan Talc Co., Ltd., average primary particle size: 5.0 μm in median diameter)

Kaolin particles: Hydrite SB100 (product name, manufactured by IMERYS S.A., average primary particle size: 1.2 μm)

Glass particles (fibrous particles): CSF 3PE-957 (product name, Nittobo Co., Ltd., average primary particle size: fiber length 3000 μm×fiber diameter 13 μm)

In addition, each of the above-mentioned inorganic fillers as component (C2) was confirmed to have a DTA curve obtained by differential thermal analysis as shown in FIG. 4, for example, showing no endotherm portion in the temperature range of 180 to 500° C.

The DTA curve obtained by differential thermal analysis of the component (C) has an endothermic portion in the temperature range of 180 to 500° C. if the component (C) contains the component (C1).

### <Other Ingredients>

Magnesium stearate: DAIWAX M (product name, manufactured by Dainichi Chemical Industry Co.)

Crystal nucleating agent: NJSTAR NU-100 (product name, manufactured by New Japan Chemical Co., Ltd.)

SEBS: TUFTEC M1911 (product name, Asahi Kasei Chemical Co., Ltd.).

### (Production of Resin Composition)

In each of the Examples and Comparative Examples, the content (mass %) of each ingredient shown in Table I, Table II and Table III was used. In the composition part of Table I, Table II and Table III, the blank columns indicate that the content of the component in question is “0”.

A twin-screw extruder HYPERKTX-30 (manufactured by Kobe Steel, Ltd.)) was used to melt-knead by setting the maximum cylinder temperature to 180° C., the die temperature to 177° C., and the screw speed to 150 rpm. The discharge rate was set to 10 kg/hr.

For Examples 9, 10, 12 and Comparative Example 3, the raw material components other than the side-feed component were dry-blended in advance and then fed from the hopper installed at the very end of the twin-screw extruder. The side-feed components were fed from the side feeder installed in the center of the cylinder. For the other Examples and Comparative Examples, all the raw material components were dry-blended in advance and fed from the hopper installed at the rearmost part of the cylinder of the twin-screw extruder.

The side feed components in Examples 9, 10, 12 and Comparative Example 3 were, respectively, wollastonite particles 1, glass particles (fibrous particles), phosphate ester 2, and glass particles (fibrous particles).

The strands discharged from the extruder were cut by a pelletizer and processed into pellets of about 3 mm in diameter×5 mm in length to form the resin composition.

### [Physical Properties of Resin Composition]

The resin compositions of Examples 1 to 18 and Comparative Examples 1 to 6 obtained above were subjected to the following measurement of physical properties (i) to (iv). The results are shown in Tables I, II and III.

### (i) Relationship Between the Maximum Particle Size of Component (C)

For any part of the pellets of each resin composition obtained above, the area with a distance of 1 mm or more from the topmost surface to the center was observed.

The number of particles having a maximum diameter of 100 μm or more, the number of particles having a maximum diameter of 200 μm or more, and the number of particles having a maximum diameter of 300 μm or more were counted in a viewing area of 480 μm×360 μm in size photographed by a scanning electron microscope: JSM-7401F (JEOL Ltd.) at a magnification of 300 times. The viewing area of 480 μm×360 μm is, for example, four times the size (240 μm×180 μm) that can be obtained in one image when photographed at a magnification of 300 times (twice both vertically and horizontally). The area is divided into 4 images (2 vertical×2 horizontal=4 images) and photographed, then, the number of particles having the maximum diameter is counted as the viewing area of the above size.

FIG. 1 shows an image (240 μm×180 μm) of a cross section of the resin composition obtained in Example 1 taken with an electron microscope (300 times). The image shown in FIG. 1 is one of four images obtained by dividing the viewing area of 480 μm×360 μm in which the number of particles having the maximum diameter is counted into four parts.

Here, in the image shown in FIG. 1, there are no particles having a maximum diameter of 300 μm or more and no particles having a maximum diameter of 100 μm or more. Similarly, for the remaining three images, the number of particles having a maximum diameter of 300 μm or more and the number of particles having a maximum diameter of 100 μm or more are counted.

The ratio value of the number of particles having a maximum diameter of 300 μm or more to the number of particles having a maximum diameter of 100 μm or more was obtained from the total of the four sheets. In addition, the ratio value of the number of particles having a maximum diameter of 200 μm or more to the number of particles having a maximum diameter of 100 μm or more was obtained.

The images were taken at 10 randomly selected viewing areas of the above sizes. The ratio values of the number of particles having a maximum diameter of 200 μm or more to the number of particles having a maximum diameter of 100 μm or more were obtained at each measurement location. These were averaged to calculate the ratio value for the requirement (2) and the ratio value for the requirement (3).

The number of particles having a maximum diameter of less than 5 μm and the number of particles having a maximum diameter of 5 μm or more were determined by using images at 10 randomly selected locations. The images (24 μm×1.8 μm viewing area) were taken at a magnification of 5000 times using a scanning electron microscope JSM-7401F (JEOL Ltd.). FIG. 2 shows one of the images of the cross section of the resin composition obtained in Example 1 taken with an electron microscope (5000 times).

The number of particles having a maximum diameter of less than 5 μm and the number of particles having a maximum diameter of 5 μm or more, as measured by images taken at 10 randomly selected viewing areas of the above sizes, were obtained. At each measurement location, the ratio value of the number of particles having a maximum diameter of less than 5 μm to the number of particles having a maximum diameter of 5 μm or more was obtained. These were averaged to calculate the ratio value for the requirement in (4).

The ratio value for the requirement in (2): The ratio value of the number of particles having a maximum diameter of 300 μm or more to the number of particles having a maximum diameter of 100 μm or more (indicated as “300 μm or more/100 μm or more” in the table).

The ratio value for the requirement in (3): The ratio value of the number of particles having a maximum diameter of 200 μm or more to the number of particles having a maximum diameter of 100 μm or more (indicated as “200 μm or more/100 μm or more” in the table).

The ration value for the requirement in (4): The ratio value of the number of particles having a maximum diameter of less than 5 μm to the number of particles having a maximum diameter of 5 μm or more (indicated as “less than 5 μm/5 μm or more” in the table).

### (ii) Measurement of Phosphorus Content (Mass %)

The phosphorus content was measured using pellets of each resin composition obtained above. The phosphorus content (mass %) was measured using an energy dispersive X-ray fluorescence analyzer JSX-1000S (JEOL Ltd.).

(iii) DTA Measurement

The pellets of each resin composition obtained above were subjected to differential thermal analysis (DTG-60A, Shimadzu, Inc., under N₂ gas atmosphere, temperature increase condition: 10° C./min). Thus, a DTA curve was obtained. The DTA curve was checked to see if there was an endothermic portion in the temperature range of 180 to 350° C. The results for Example 1 are shown in FIG. 5. The table also shows the DTA curves for each of the examples and the comparative examples. The presence or absence of endothermic portion in the temperature range of 180 to 350° C. is described in the table.

The resin compositions obtained in Examples 6 and 10 contain the endothermic inorganic filler (C1). However, the resin compositions themselves don't have an endothermic portion in the temperature range of 180 to 350° C. in the DTA curve. The reason for this is believed to be due to the influence of components other than the endothermic inorganic filler (C1).

### (iv) Measurement of Halogen Content

Using the pellets of each resin composition obtained above, the content of halogen elements in the resin composition was measured by flask combustion treatment ion chromatography. The results showed that in any of the resin compositions, the content of chlorine was 900 mass ppm or less, the content of bromine was 900 mass ppm or less, and the total content of chlorine and bromine was 1500 ppm or less.

### <Evaluation>

The resin compositions of Examples 1 to 18 and Comparative Examples 1 to 6 obtained above were evaluated for mechanical strength (flexural modulus and impact strength) and flame retardancy by performing the following evaluations. The results are shown in Tables I, II and III.

### (Production Conditions of Test Piece)

The pellets of the resin composition of each Example and Comparative Example were dried at 80° C. for 4 hours, and then molded by an injection molding machine (Roboshot S-2000i 50 Bp, manufactured by FANUC Corporation) to produce molded products for evaluation. The maximum cylinder temperature during molding was 200° C., and the mold temperature was 80° C.

### (1) Measurement of Flexural Modulus

Under the molding conditions described above, the test pieces were formed into a strip-form of 80 mm×10 mm×4 mm, and flexural tests were conducted according to JIS-K7171 (ISO178), and the flexural modulus [GPa] was measured and evaluated based on the following criteria. When the flexural modulus was 1.2 GPa or more, the strength of the molded product was judged to be acceptable for practical use.

### (Evaluation Criteria)

AA: 1.8 GPa or more
BB: 1.5 GPa or more, and less than 1.8 GPa
CC: 1.2 GPa or more, and less than 1.5 GPa
DD: Less than 1.2 GPa

### (2-1) Notched Charpy Impact Strength Measurement

Under the molding conditions described above, a strip-form test piece (80 mm×10 mm×4 mm) (notched) was prepared based on the method of JIS-K7111-1 (ISO 179-1), and the notched Charpy impact test was conducted. The notched Charpy impact strength [kJ/m²] was measured and evaluated based on the following criteria. When the notched Charpy impact strength was 6 kJ/m² or more, the toughness of the molded product was judged to be acceptable for practical use.

### (Evaluation Criteria)

AA: 10 kJ/m² or more
BB: 8 kJ/m² or more, and less than 10 kJ/m²
CC: 6 k kJ/m² or more, and less than 8 kJ/m²
DD: Less than 6 k kJ/m²

### (2-2) Un-Notched Charpy Impact Strength Measurement

Under the molding conditions described above, a strip-form test piece (80 mm×10 mm×4 mm) (un-notched) was prepared based on the method of JIS-K7111-1 (ISO 179-1), and the un-notched Charpy impact test was conducted. The un-notched Charpy impact strength [kJ/m] was measured and evaluated based on the following criteria. When the un-notched Charpy impact strength was 60 kJ/m² or more, the toughness of the molded product was judged to be acceptable for practical use.

### (Evaluation Criteria)

AA: 90 kJ/m² or more, or NB (Not Broken)
BB: 80 kJ/m² or more, and less than 90 kJ/m²
CC: 60 kJ/m² or more, and less than 80 kJ/m²
DD: Less than 60 kJ/m²

### (3-1) Combustion Test (Flame Retardancy Evaluation)

Under the molding conditions described above, the strip-type test pieces (5 pieces each) of 125 mm×12.5 mm×1.6 mm were prepared. The test specimens were subjected to a combustion test in accordance with UL94V, and evaluated according to the following criteria. The test pieces were evaluated based on the following criteria. It was judged that there was no problem in practical use when the judgment of the combustion test was V-2 or higher.

### (Evaluation Criteria)

AA: The one having a judgment of any one of V-0, V-1, or V-2.
BB: The one having a judgment of “not V” (the one that does not achieve a V-2 level).

### (3-2) Combustion Test (Average Combustion Time)

In the above UL94V compliant test (vertical combustion test), a flame was applied to the lower end of the test piece for 10 seconds. The time until extinguished (combustion time) was measured. The test was repeated twice on the same test piece, with T1 being the combustion time at the first flame contact and T2 being the combustion time at the second flame contact. The average value (T1+T2)/2 was calculated as the burning time of the specimen. The same test as above was conducted on five pieces, and the average value of the burning time in the five piece was taken as the average burning time (sec), which was evaluated based on the following criteria. When the average burning time was less than 30 seconds, it was judged that there was no problem in practical use.

### (Evaluation Criteria)

AA: 10 seconds or less
BB: More than 10 seconds, and 20 seconds or less
CC: More than 20 seconds, and less than 30 seconds
DD: 30 seconds or more, or Burn out

TABLE I

| | | | | Exam- | Exam- | Exam- | Exam- | Exam- | Exam- | Exam- | Exam- | Exam- |
|---|---|---|---|---|---|---|---|---|---|---|---|---|
| | | | | ple 1 | ple 2 | ple 3 | ple 4 | ple 5 | ple 6 | ple 7 | ple 8 | ple 9 |
| Compo- | Polyolefin | | Polypropylene-based resin 1 | 74% | 72% | 73% | 70% | 56% | 73% | 41% | 89% | 73% |
| sition | resin | | Polypropylene-based resin 2 | | | | | | | | | |
| (mass %) | | | Polyethylene-based resin | | | | | | | | | |
| | Component | | Phosphate ester compound 1 | 5.0% | 6.0% | 5.0% | 3.0% | 25.0% | 1.0% | 7.0% | 4.0% | 5.0% |
| | (A) | | Phosphate ester compound 2 | | | | | | | | | |
| | Component | | NOR-type hindered amine 1 | 1.0% | 1.0% | 2.0% | 2.0% | 0.1% | 5.0% | 2.0% | 1.0% | 2.0% |
| | (B) | | NOR-type hindered amine 2 | | | | | | | | | |
| | Compo- | Compo- | Aluminum hydroxide | 10.0% | 15.0% | 5.0% | 10.0% | 5.0% | 10.0% | 20.0% | 5.0% | 10.0% |
| | nent | nent | particles | | | | | | | | | |
| | (C) | (C1) | Magnesium hydroxide | | | | | | | | | |
| | | | particles | | | | | | | | | |
| | | Compo- | Wollastonite particles 1 | 5.0% | 5.0% | 10.0% | 5.0% | 5.0% | 5.0% | | | 5.0% |
| | | nent | Wollastonite particles 2 | | | | | | | | | |
| | | (C2) | Calcium carbonate particles | 5.0% | | 5.0% | 10.0% | 5.0% | 5.0% | 15.0% | | 5.0% |
| | | | Mica particles | | | | | | | | | |
| | | | Talc particles | | | | | | | | | |
| | | | Kaolin particles | | | | | | | 15.0% | | |
| | | | Glass particles | | | | | | | | | |
| | | | (fibrous particles) | | | | | | | | | |

| | | | | | | | | | | |
|---|---|---|---|---|---|---|---|---|---|---|
| Dispersing agent | Magnesium stearate | 0.5% | 0.5% | 0.5% | 0.5% | 0.5% | 0.5% | 0.5% | 0.5% | 0.5% |
| Other additive | Crystal nucleating agent | | 0.1% | | | | 0.1% | | 0.1% | |
| | SEBS | | | | | 3.0% | | | | |

| | Total | | | 100% | 100% | 100% | 100% | 100% | 100% | 100% | 100% | 100% |
|---|---|---|---|---|---|---|---|---|---|---|---|---|
| | Total of Component (C) | | | 20.0% | 20.0% | 20.0% | 25.0% | 15.0% | 20.0% | 50.0% | 5.0% | 20.0% |
| | (Component (C1) + Component (C2)) | | | | | | | | | | | |
| Physical | Phosphor atom content (mass %) | | | 0.4% | 0.5% | 0.4% | 0.3% | 2.2% | 0.1% | 0.6% | 0.4% | 0.4% |
| Properties | Relationship | | 300 μm or more/ | 0.00 | 0.00 | 0.00 | 0.00 | 0.00 | 0.00 | 0.04 | 0.00 | 0.07 |
| of Compo- | of Maximum | | 100 μm or more | | | | | | | | | |
| sition | particle size | | 200 μm or more/ | 0.00 | 0.00 | 0.00 | 0.00 | 0.00 | 0.00 | 0.05 | 0.00 | 0.10 |
| | (SEM image) | | 100 μm or more | | | | | | | | | |
| | | | Less than 5 μm/ | 51 | 38 | 31 | 94 | 70 | 47 | 18 | ∞ | 14 |
| | | | 5 μm or more | | | | | | | | | |
| | Presence or absence of Endothermic portion | | | Present | Present | Present | Present | Present | Absent | Present | Present | Present |
| Evaluation | Flame | UL94V Test | Evaluation | AA | AA | AA | AA | AA | AA | AA | AA | AA |
| | retardancy | | V Rank | V-2 | V-2 | V-2 | V-2 | V-2 | V-2 | V-2 | V-2 | V-2 |
| | | Average | Evaluation | BB | AA | BB | BB | AA | AA | CC | BB | CC |
| | | combustion | Measured | 12 | 8 | 12 | 15 | 4 | 4 | 22 | 15 | 22 |
| | | time | value [sec] | | | | | | | | | |
| | Toughness | Un-notched | Evaluation | AA | AA | AA | AA | CC | AA | CC | AA | BB |
| | | Charpy | Measured | NB | NB | NB | NB | 62 | NB | 63 | NB | 85 |
| | | impact | value [kJ/m²] | | | | | | | | | |
| | | Notched | Evaluation | BB | BB | CC | AA | CC | AA | CC | BB | CC |
| | | Charpy | Measured | 9 | 8 | 7 | 12 | 6 | 11 | 6 | 9 | 7 |
| | | impact | value [kJ/m²] | | | | | | | | | |
| | | strength | | | | | | | | | | |
| | Rigidity | Flexural | Evaluation | BB | AA | AA | BB | CC | AA | AA | CC | AA |
| | | modulus | Measured | 1.7 | 2.0 | 2.2 | 1.6 | 1.2 | 2.1 | 3.8 | 1.2 | 2.3 |
| | | | value [GPa] | | | | | | | | | |

TABLE II

| | | | | Exam- | Exam- | Exam- | Exam- | Exam- | Exam- | Exam- | Exam- | Exam- |
|---|---|---|---|---|---|---|---|---|---|---|---|---|
| | | | | ple 10 | ple 11 | ple 12 | ple 13 | ple 14 | ple 15 | ple 16 | ple 17 | ple 18 |
| Compo- | Polyolefin | | Polypropylene-based resin 1 | 71% | 0% | 71% | 73% | 72% | 72% | 55% | 72% | 74% |
| sition | resin | | Polypropylene-based resin 2 | | | | | | | 20% | | |
| (mass %) | | | Polyethylene-based resin | | 73% | | | | | | | |
| | Component | | Phosphate ester compound 1 | 5.0% | 5.0% | | 5.0% | 5.0% | 5.0% | 3.0% | 6.0% | 5.0% |
| | (A) | | Phosphate ester compound 2 | | | 5.0% | | | | | | |
| | Component | | NOR-type hindered amine 1 | 3.5% | 1.5% | 0.5% | | 2.0% | 2.0% | | 1.5% | 1.0% |
| | (B) | | NOR-type hindered amine 2 | | | | 1.0% | | | 1.5% | | |
| | Compo- | Compo- | Aluminum hydroxide | 5.0% | 10.0% | 10.0% | 12.0% | 10.0% | 10.0% | 10.0% | | 10.0% |
| | nent | nent | particles | | | | | | | | | |
| | (C) | (C1) | Magnesium hydroxide | | | | | | | | 10.0% | |
| | | | particles | | | | | | | | | |
| | | Compo- | Wollastonite particles 1 | | 5.0% | 5.0% | 5.0% | | | 5.0% | 5.0% | 5.0% |
| | | nent | Wollastonite particles 2 | | | | | | | | | |
| | | (C2) | Calcium carbonate particles | 5.0% | 5.0% | 5.0% | 3.0% | | | 5.0% | 5.0% | 5.0% |
| | | | Mica particles | | | | | 10.0% | | | | |
| | | | Talc particles | | | | | | 10.0% | | | |
| | | | Kaolin particles | | | | | | | | | |
| | | | Glass particles | 10.0% | | | | | | | | |
| | | | (fibrous particles) | | | | | | | | | |

| | Dispersing agent | Magnesium stearate | 0.5% | 0.5% | 0.5% | 0.5% | 0.5% | 0.5% | 0.5% | 0.5% | |
|---|---|---|---|---|---|---|---|---|---|---|---|
| | Other additive | Crystal nucleating agent | | | | 0.1% | 0.1% | 0.1% | | | |
| | | SEBS | | | 3.0% | | | | | | |
| | Total | | 100% | 100% | 100% | 100% | 100% | 100% | 100% | 100% | 100% |
| | Total of Component (C) | | 20.0% | 20.0% | 20.0% | 20.0% | 20.0% | 20.0% | 20.0% | 20.0% | 20.0% |
| | (Component (C1) + Component (C2)) | | | | | | | | | | |
| Physical | Phosphor atom content (mass %) | | 0.4% | 0.4% | 0.4% | 0.4% | 0.4% | 0.4% | 0.3% | 0.5% | 0.4% |
| Properties | Relationship | 300 μm or more/ | 0.10 | 0.00 | 0.00 | 0.00 | 0.03 | 0.00 | 0.00 | 0.00 | 0.00 |
| of Compo- | of Maximum | 100 μm or more | | | | | | | | | |
| sition | particle size | 200 μm or more/ | 0.14 | 0.00 | 0.00 | 0.00 | 0.07 | 0.00 | 0.00 | 0.00 | 0.00 |
| | (SEM image) | 100 μm or more | | | | | | | | | |
| | | Less than 5 μm/ | 24 | 53 | 52 | 59 | 33 | 22 | 31 | 25 | 8 |
| | | 5 μm or more | | | | | | | | | |

| | Presence or absence of Endothermic portion | | | Absent | Present | Present | Present | Present | Present | Present | Present | Present |
|---|---|---|---|---|---|---|---|---|---|---|---|---|
| Evaluation | Flame | UL94V Test | Evaluation | AA | AA | AA | AA | AA | AA | AA | AA | AA |
| | retardancy | | V Rank | V-2 | V-2 | V-2 | V-2 | V-2 | V-2 | V-2 | V-2 | V-2 |
| | | Average | Evaluation | CC | BB | CC | BB | BB | CC | BB | CC | BB |
| | | combustion | Measured | 24 | 11 | 22 | 15 | 20 | 23 | 11 | 26 | 18 |
| | | time | value [sec] | | | | | | | | | |
| | Toughness | Un-notched | Evaluation | CC | AA | AA | AA | BB | BB | AA | AA | AA |
| | | Charpy | Measured | 60 | NB | NB | NB | 61 | 88 | NB | NB | NB |
| | | impact | value [kJ/m²] | | | | | | | | | |
| | | strength | | | | | | | | | | |
| | | Notched | Evaluation | BB | CC | AA | BB | CC | CC | CC | BB | CC |
| | | Charpy | Measured | 8 | 7 | 10 | 9 | 7 | 6 | 7 | 8 | 7 |
| | | impact | value [kJ/m²] | | | | | | | | | |
| | | strength | or NB | | | | | | | | | |
| | Rigidity | Flexural | Evaluation | AA | BB | CC | AA | AA | AA | AA | AA | AA |
| | | modulus | Measured | 3.5 | 1.7 | 1.4 | 2.1 | 2.5 | 2.4 | 2.3 | 1.9 | 1.8 |
| | | | value [GPa] | | | | | | | | | |

TABLE III

| | | | | Compar- | Compar- | Compar- | Compar- | Compar- | Compar- |
|---|---|---|---|---|---|---|---|---|---|
| | | | | ative | ative | ative | ative | ative | ative |
| | | | | Exam- | Exam- | Exam- | Exam- | Exam- | Exam- |
| | | | | ple 1 | ple 2 | ple 3 | ple 4 | ple5 | ple 6 |
| Compo- | Polyolefin | | Polypropylene-based resin 1 | 79% | 54% | 74% | 37% | 74% | 75% |
| sition | resin | | Polypropylene-based resin 2 | | | | | | |
| (mass %) | | | Polyethylene-based resin | | | | | | |
| | Component | | Phosphate ester compound 1 | | 30.0% | 5.0% | 7.0% | 5.0% | 5.0% |
| | (A) | | Phosphate ester compound 2 | | | | | | |
| | Component | | NOR-type hindered amine 1 | 1.0% | 0.5% | 0.5% | 1.0% | 1.0% | |
| | (B) | | NOR-type hindered amine 2 | | | | | | |
| | Compo- | Compo- | Aluminum hydroxide | 10.0% | 5.0% | 10.0% | 55.0% | | 15.0% |
| | nent | nent | particles | | | | | | |
| | (C) | (C1) | Magnesium hydroxide | | | | | | |
| | | | particles | | | | | | |
| | | Compo- | Wollastonite particles 1 | 5.0% | 5.0% | | | 10.0% | 5.0% |
| | | nent | Wollastonite particles 2 | | | | | | |
| | | (C2) | Calcium carbonate particles | 5.0% | 5.0% | 5.0% | | 10.0% | |
| | | | Mica particles | | | | | | |
| | | | Talc particles | | | | | | |
| | | | Kaolin particles | | | | | | |
| | | | Glass particles | | | 5.0% | | | |
| | | | (fibrous particles) | | | | | | |

| | Dispersing agent | Magnesium stearate | 0.5% | 0.5% | 0.5% | | 0.5% | 0.5% |
|---|---|---|---|---|---|---|---|---|
| | Other additive | Crystal nucleating agent | | 0.1% | 0.1% | | | |
| | | SEBS | | | | | | |
| | Total | | 100% | 100% | 100% | 100% | 100% | 100% |
| | Total of Component (C) | | 20.0% | 15.0% | 20.0% | 55.0% | 20.0% | 20.0% |
| | (Component (C1) + Component (C2)) | | | | | | | |
| Physical | Phosphor atom content (mass %) | | 0.00% | 2.63% | 0.44% | 0.61% | 0.44% | 0.44% |
| Properties | Relationship | 300 μm or more/ | 0.00 | 0.00 | 0.50 | 0.40 | 0.00 | 0.00 |
| of Compo- | of Maximum | 100 μm or more | | | | | | |
| sition | particle size | 200 μm or more/ | 0.00 | 0.00 | 0.63 | 0.71 | 0.00 | 0.00 |
| | (SEM image) | 100 μm or more | | | | | | |
| | | Less than 5 μm/ | 44 | 57 | 50 | 9 | 40 | 42 |
| | | 5 μm or more | | | | | | |

| | Presence or absence of Endothermic portion | | | Present | Present | Present | Present | Absent | Present |
|---|---|---|---|---|---|---|---|---|---|
| Evaluation | Flame | UL94V Test | Evaluation | BB | AA | BB | AA | BB | BB |
| | retardancy | | V Rank | notV | V-2 | notV | V-2 | notV | notV |
| | | Average | Evaluation | DD | AA | DD | AA | DD | DD |
| | | combustion | Measured | Burn out | 6 | Burn out | 5 | Burn out | Burn out |
| | | time | value [sec] | | | | | | |
| | Toughness | Un-notched | Evaluation | AA | DD | CC | DD | AA | AA |
| | | Charpy | Measured | NB | 54 | 74 | 28 | NB | NB |
| | | impact | value [kJ/m²] | | | | | | |
| | | strength | | | | | | | |
| | | Notched | Evaluation | BB | DD | BB | DD | BB | AA |
| | | Charpy | Measured | 9 | 3 | 8 | 3 | 8 | 10 |
| | | impact | value [kJ/m²] | | | | | | |
| | | strength | or NB | | | | | | |
| | Rigidity | Flexural | Evaluation | AA | CC | AA | AA | AA | AA |
| | | modulus | Measured | 1.8 | 1.3 | 2.5 | 3.9 | 1.8 | 1.8 |
| | | | value [GPa] | | | | | | |

From Tables I, II and III, it can be seen that the resin compositions of the present invention may be used to economically produce molded products with excellent mechanical strength and flame retardancy with stable quality.

Although embodiments of the present invention lave been described and illustrated in detail, the disclosed embodiments are made for purposes of illustration and example only and not limitation. The scope of the present invention should be interpreted by terms of the appended claims.

What is claimed is:

1. A halogen-free resin composition including a polyolefin resin, containing
a phosphorus compound in an amount of 0.05 to 2.5 mass % as a phosphorus content;
a NOR-type hindered amine in an amount of 0.05 to 3 mass %; and
an inorganic filler in an amount of 3 to 50 mass %, respectively, with respect to the total amount of the resin composition,
wherein a DTA (Differential Thermal Analysis) curve obtained by differential thermal analysis of the inorganic filler has an endothermic portion in a temperature range of 180 to 500° C.; and
in the inorganic filler, a ratio value of a number of particles having a maximum diameter of 300 μm or more to a number of particles having a maximum diameter of 100 μm or more is ⅕ or less, or there are no particles having a maximum diameter of 100 μm or more.

2. The halogen-free resin composition according to claim 1, containing the inorganic filler composed of: at least one selected from the group of aluminum hydroxide particles, boehmite particles, magnesium hydroxide particles, and hydromagnesite particles; and at least one selected from the group of wollastonite particles, talc particles, mica particles, glass particles, kaolin particles, magnesium sulfate particles, calcium carbonate particles, and silica particles.

3. The halogen-free resin composition according to claim 1, wherein the polyolefin resin is a polypropylene-based resin.

4. The halogen-free resin composition according to claim 1, wherein the phosphorus compound includes a phosphate ester compound.

5. The halogen-free resin composition according to claim 1, wherein the resin composition has an endothermic portion in a temperature range of 180 to 350° C. in a DTA curve obtained by differential thermal analysis of the resin composition under a temperature increase condition of 10° C./minute.

6. The halogen-free resin composition according to claim 1, containing:
the phosphorus compound in an amount of 0.1 to 1.5 mass % as a phosphorus content;
the NOR-type hindered amine in an amount of 0.1 to 2 mass %; and
the inorganic filler in an amount of 10 to 30 mas %, respectively, with respect to the total amount of the resin composition,
wherein the inorganic filler contains an endothermic inorganic filler whose DTA curve obtained by differential thermal analysis exhibits an endothermic portion in a temperature range of 180 to 500° C. in an amount of 3 mass % or more with respect to the total amount of the resin composition, and the inorganic filler preferably satisfies the following (a) or (b):
(a) a ratio value of a number of particles having a maximum diameter of 200 μm or more to a number of particles having a maximum diameter of 100 μm or more is 1/10 or less, or there are no particles having a maximum diameter of 100 μm or more, and a ratio value of a number of particles having a maximum diameter of less than 3 μm to a number of particles having a maximum diameter of 3 μm or more is 10 or more,
(b) there are no particles having a maximum diameter of 3 μm or more.

7. The halogen-free resin composition according to claim 1, further containing a fatty acid or a salt thereof.

8. A method for producing the resin composition according to claim 1, comprising the step of:
kneading raw material components containing the polyolefin resin, the phosphorus compound, the NOR-type hindered amine, and the inorganic filler with a twin-screw extruder.
